(19) United States
(12) Patent Application Publication
(10) Pub. No.: US 2011/0238394 A1
(43) Pub. Date: Sep. 29, 2011

(54) Method and recording medium of a hybrid approach to multiple fluid simulation using volume fraction

(76) Inventors: Sung Yong Shin, Daejeon (KR); Nahyup KANG, Daejeon (KR)

(21) Appl. No.: 12/805,553

(22) Filed: Aug. 5, 2010

(30) Foreign Application Priority Data
Mar. 23, 2010 (KR) 10-2010-0025894

(51) Int. Cl. G06G 7/48

(52) U.S. Cl. 703/9

(57) ABSTRACT

Provided are a method of a hybrid approach to multiple fluid simulation using volume fractions for realizing computer graphics through analysis of the Navier-Stokes equations, which is executed via a computer and takes into account variable densities and variable viscosities resulting from N multiple fluids existing in multiple lattice cells, and a recording medium wherein a program of the method is recorded.

### CROSS-REFERENCE TO RELATED APPLICATIONS

This application claims priority under 35 U.S.C. §119 to Korean Patent Application No. 10-2010-0025894, filed on Mar. 23, 2010, the disclosure of which is incorporated herein by reference in its entirety.

### TECHNICAL FIELD

The following disclosure relates to a method of a hybrid approach to multiple fluid simulation using volume fractions for realizing computer graphics through analysis of the Navier-Stokes equations, which is executed via a computer and takes into account variable densities and viscosities resulting from N multiple fluids existing in multiple lattice cells, and a recording medium wherein a program of the method is recorded.

### BACKGROUND

Due to recent advancement of fluid simulation technology, multiple fluid interactions have drawn much attention from the computer animation community. The existing techniques for analysis of the multiple fluid interactions are as follows. Premoze et al. presented a particle-based method which can simulate multiple immiscible fluids [Premoze S., Tasdizen T., Bigler J., Lefohn A., Whitaker R. T.: Particle-based simulation of fluids. Computer Graphics Forum 22 (2003), 401-410(10)]. Muller et al. [Muller M., Solenthaler B., Keiser R., Gross M.: Particle-based fluid-fluid interaction. In SCA '05: Proceedings of the 2005 ACM SIGGRAPH/Eurographics Symposium on Computer Animation (New York, N.Y., USA, 2005), ACM, pp. 237-244.] proposed a smoothed-particle hydrodynamics (SPH)-based method [Monaghan J.: Smoothed particle hydrodynamics. Reports on Progress in Physics 68 (2005), 1703-1759(57).; Muller M., Charypar D., Gross M.: Particle based fluid simulation for interactive applications. In SCA '03: Proceedings of the 2003 ACM SIGGRAPH/Eurographics Symposium on Computer Animation (Aire-la-Ville, Switzerland, 2003), Eurographics Association, pp. 154-159.] for modelling the fluid-fluid interaction. Hong et al. [Hong J. M., Kim C. H.: Discontinuous fluids. ACM Trans. Graph. 24, 3 (2005), 915-920.] simulated incompressible viscous two-phase fluids with realistic small-scale details using ghost fluid methods [Liux X. D., Fedkiw R. P., Kang M.: A boundary condition capturing method for Poisson's equation on irregular domains. J. Comput. Phys. 160, 1 (2000), 151-178.; Kang M., Fedkiw R. P., Liux X. D.: A boundary condition capturing method for multiphase incompressible flow. J. Sci. Comput. 15, 3 (2000), 323-360.]. Losasso et al. [Losasso F., Shinar T., Selle A., Fedkiw R.: Multiple interacting liquids. ACM Trans. Graph. 25, 3 (2006), 812-819.] simulated multiple immiscible fluids by extending particle level set methods [Enright D., Fedkiw R., Ferziger J., Mitchell I.: A hybrid particle level set method for improved interface capturing. J. Comput. Phys. 183, 1 (2002), 83-116.; Enright D., Losasso F., Fedkiw R.: A fast and accurate semi-Lagrangian particle level set method. Computers and Structures 83 (2005), 479-490.; Enright D., Marschner S., Fedkiw R.: Animation and rendering of complex water surfaces. ACM Trans. Graph. 21, 3 (2002), 736-744.] on an Eulerian grid. These particle level set methods cannot be extended to multiple miscible fluid simulation since the methods assume that the density is constant inside the fluid. However, for the accurate tracking of the volume fractions near the interface between immiscible fluids, the particle-based level set method by Losasso et al. [Losasso F., Shinar T., Selle A., Fedkiw R.: Multiple interacting liquids. ACM Trans. Graph. 25, 3 (2006), 812-819.] is employed in the present invention.

Zhu et al. [Zhu H., Liu X., Liu Y., Wu E.: Simulation of miscible binary mixtures based on lattice Boltzmann method. Computer Animation and Virtual Worlds 17, 3-4 (2006), 403-410.; Zhu H., Bao K., Wu E., Liu X.: Stable and efficient miscible liquid-liquid interactions. In VRST '07: Proceedings of the 2007 ACM symposium on Virtual reality software and technology (New York, N.Y., USA, 2007), ACM, pp. 55-64.] simulated a pair of miscible fluids based on a lattice Boltzmann method. lattice Boltzmann method-based approaches suffer from instability that tends to produce high-Reynolds number effects, resulting in viscous-looking fluid flows. Moreover, the lattice Boltzmann method-based method cannot deal with the divergence-free condition of fluids. In the present invention, Navier-Stokes equations are solved in order to satisfy the divergence-free condition for multiple fluids regardless of their miscibility, using the operator-splitting framework [Stam J.: Stable fluids. In SIGGRAPH '99: Proceedings of the 26th annual conference on Computer graphics and interactive techniques (New York, N.Y., USA, 1999), ACM Press/Addison-Wesley Publishing Co., pp. 121-178.]. Recently, Mullen et al. [Mullen P., McKenzie A., Tong Y., Desbrun M.: A variational approach to Eulerian geometry processing. ACM Trans. Graph. 26, 3 (2007), 66.] proposed a mass-preserving density advection method that can handle miscible fluids. However, this method does not take into account variable densities and viscosities. Moreover, it is not obvious how to extend the method to handle both multiple miscible and immiscible e fluids.

Park et al. [Park J., Kim Y., Wi D., Kang N., Shin S. Y., Noh J.: A unified handling of immiscible and miscible fluids. Computer Animation and Virtual Worlds 19, 3-4 (2008), 455-467.] presented a lattice Boltzmann method-based approach to simulate more complex phenomena involving both miscible and immiscible e fluids based on a phase field method (PFM) [Anderson D. M., McFadden G. B., Wheeler A. A.: Diffuse-interface methods in fluid mechanics. Annual Review of Fluid Mechanics 30 (1998), 139-165.]. This approach suffers from several imitations such as volume loss, large memory requirements, and viscous-looking flow generation. Moreover, the governing equations of the PFM include a 4th order differential term, which makes it difficult to solve them numerically and tends to smooth out the fluid interface so as to make small drops shrink spontaneously.

The existing volume-of-fluid (VOF)-based analysis techniques are as follows. VOF methods [Hirt C. W., Nichols B. D.: Volume of fluid (vof) method for the dynamics of free boundaries. Journal of Computational Physics 39, 1 (1981), 201-225.] have been used widely as alternatives for tracking fluids on an Eulerian grid. The VOF method does not track the motion of the interface between fluids, but evolves the volume fraction of each fluid. The interface between fluids is reconstructed from the volume fractions by employing an approximation method such as the piecewise linear interface calculation (PLIC) scheme [Youngs D.: Time-dependent multimaterial flow with large fluid distortion. K. Morton, M. Baines (Eds.), Numerical Methods for Fluid Dynamics, Academic Press, New York, (1982), 273-285.]. The main advantage of the VOF method is that it can conserve fluid volumes explicitly by computing volume fluxes. However, the reconstruction of the material interface while satisfying the volume constraints over a spatial domain is a difficult problem because of its under-constrained nature. The PLIC scheme also suffers from several limitations such as discontinuity across the cell boundaries and ambiguity for three or more materials. Several variations of the PLIC scheme have been presented to resolve those limitations [Pilliod Jr. J. E., Puckett E. G.: Second-order accurate volume-of-fluid algorithms for tracking material interfaces. J. Comput. Phys. 199, 2 (2004), 465-502.; Garimella R. V., Dyadechko V., Swartz B. K., Shashkov M. J.: Interface reconstruction in multi-fluid, multiphase flow simulations. In Proc. of International Meshing Roundtable (September 2005), pp. 19-32.; Anderson J. C., Garth C., Duchaineau M. A., Joy K. I.: Discrete multi-material interface reconstruction for volume fraction data. Computer Graphics Forum 27, 3 (2008), 1015-1022.]. Yet, another limitation lies in difficulty of computing interfacial normals and curvatures that are important to solve the Navier-Stokes equations, in particular, to solve surface tension forces.

Sussman et al. presented a hybrid approach by coupling a level set method and a VOF method (CLSVOF) [Sussman M., Puckett E. G.: A coupled level set and volume-of-fluid method for computing 3D and axisymmetric incompressible two-phase flows. Journal of Computational Physics 162, 2 (2000), 301-337.; Sussman M.: A second order coupled level set and volume-of-fluid method for computing growth and collapse of vapor bubbles. Journal of Computational Physics 187, 1 (2003), 110-136.; Mihalef V., Unlusu B., Metaxas D., Sussman M., Hussaini M. Y.: Physics based boiling simulation. 317-324.] for accurate interfacial curvature calculation and mass conservation. In the CLSVOF method, the interface between fractions is reconstructed from the volume fractions by a PLIC scheme. Then, the reconstructed interface is used to correct a level set function from which an interfacial curvature is calculated. However, it is not easy to extend the CLSVOF method to tracking multiple fluids since both interface reconstruction and level set correction are complicated even in a two-phase fluid. A detailed comparison between particle level set methods and CLSVOF methods is well discussed in [Wang Z., Yang J., Stern F.: Comparison of particle level set and clsvof methods for interfacial flows. 46th Aerospace Sciences Meeting and Exhibit, American Institute of Aeronautics and Astronautics.; Gaudlitz D., Adams N. A.: On improving mass conservation properties of the hybrid particle-level-set method. Computers & Fluids 37, 10 (2008), 1320-1331.].

Of the existing techniques, the level set method has been employed the most frequently to simulate the motion of fluids in the field of computer graphics. According to this method, the distance from the fluid interface to each cell is recorded, and the change of the distance function with time is traced to find out the actual position at the interface. Since the location of the fluid interface is monitored geometrically, the method is very effective in representing the interface of immiscible fluids. For accurate tracking, such techniques as the particle level set method were developed. However, the distance function is limited in that it cannot represent miscible fluids. Miscible fluids can be handled effectively by using volume fractions because it is sufficient to trace only the volume fraction of each fluid in a cell. However, it is difficult to simulate immiscible fluids with the volume fractions.

Across the fluid interface, the volume fraction of each fluid changes abruptly. This change results in instability in calculating differential quantities near the interface and leads to a very large error.

### SUMMARY

To solve the problems of the existing techniques, the present invention is directed to providing a technique whereby volume fractions and level sets are combined. That is to say, by combining the two techniques, the present invention is directed to providing a method capable of effectively simulating both miscible and immiscible fluids.

The present invention is also directed to introducing the concept of distance functions to volume fractions so as to attain a smooth slope and stable differential values near the interface of miscible fluids.

In particular, in the present invention, volume fractions are adopted as the basic representation scheme for multiple fluids regardless of their miscibilities. In the present invention, the volume fractions are modified near the interface to represent a distance function as well, in order to capture both the interface between immiscible fluids and the smooth transition between miscible fluids. Based on this representation scheme, the present invention makes use of a particle level set method for tracking the interface between multiple immiscible fluids while correctly diffusing the volume fractions between miscible fluids.

The present invention is further directed to providing a technique capable of preventing unwanted diffusion between immiscible fluids when simulating the diffusion between miscible fluids.

By combining volume fractions with level sets, the present invention provides a technique capable of effectively representing multiple fluids regardless of their miscibilities.

Further, by introducing the concept of distance functions to volume fractions, a smooth slope and stable differential values are attained near the interface of miscible fluids.

Further, unwanted diffusion between immiscible fluids may be prevented when simulating the diffusion between miscible fluids.

Other features and aspects will be apparent from the following detailed description, the drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will become apparent from the following description of preferred embodiments given in conjunction with the accompanying drawings, in which:

FIG. 1 is a flowchart according to the present invention;

FIG. 2 schematically shows the volume fraction and the distance function used in the present invention;

FIG. 3 schematically shows the lattices used in discretization according to the present invention;

FIG. 4 shows an example of simulation according to the present invention;

FIG. 5 shows another example of simulation according to the present invention;

FIG. 6 shows another example of simulation according to the present invention;

FIG. 7 shows another example of simulation according to the present invention;

FIG. 8 shows another example of simulation according to the present invention;

FIG. 9 shows another example of simulation according to the present invention; and

FIG. 10 shows another example of simulation according to the present invention.

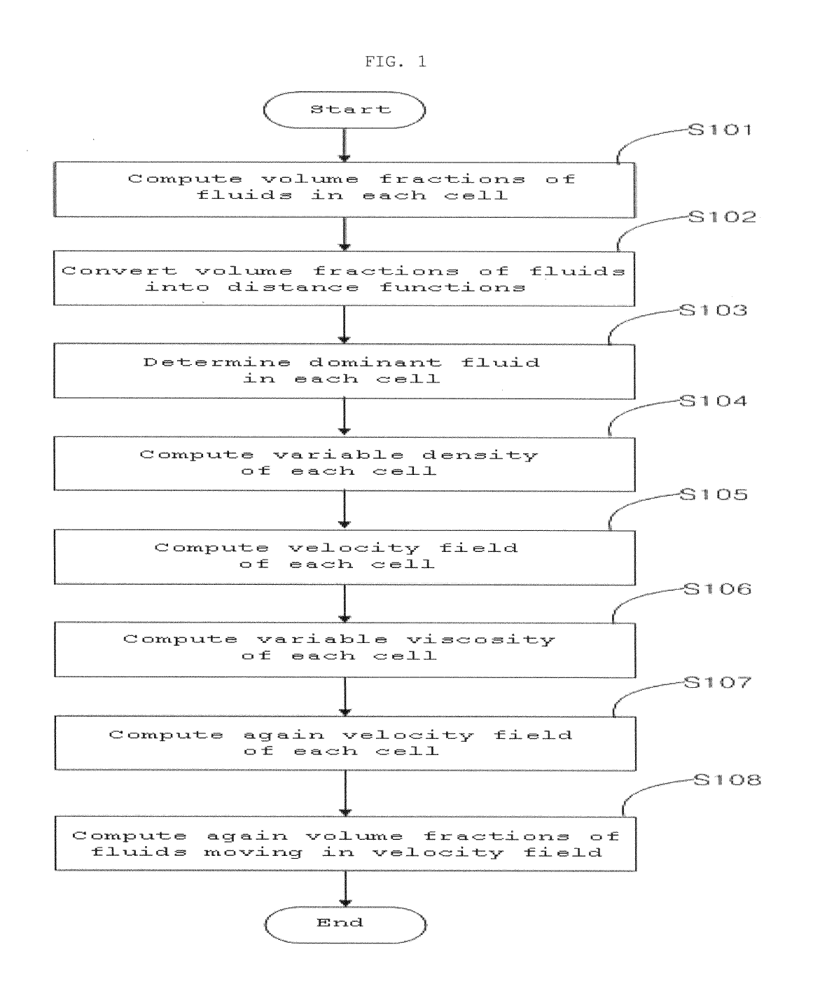

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

First, it is described how multiple fluids are represented in the present invention. For this, the groups of fluids and the volume fractions need to be defined.

In order to effectively represent multiple fluids involved in simulation, the fluids are classified into groups such that only the fluids in the same group are miscible. The miscibility of the fluids can be freely determined by a user by grouping them into different sets. Then, the simulator processes them automatically. For example, a set of four different fluids, air, water, water-soluble ink and oil, is classified into three groups {air}, {water, water-soluble ink}, and {oil}.

Then, the volume fraction is defined. Let V and v be the volume of a lattice cell and the portion of the cell volume occupied by fluid f, respectively. Then, the volume fraction of fluid f is v/V. Suppose that N fluids are involved in simulation. Then, the maximum number of fluids that can exist in one cell is N, the sum of their volumes in the cell should be V, and the sum of their volume fractions should be 1. Accordingly, the distribution of each fluid in the simulation space can be represented by computing the vector representing the volume fractions of the N fluids for each cell.

Now, it is described how the volume fractions are combined with the distance function. This is a matter of how to effectively represent miscible fluids and immiscible fluids.

In the field of computer graphics, the level set method has been employed predominantly for representation of fluids. According to this method, the distance from the fluid interface to each cell is recorded, and the change of the distance function with time is traced to find out the actual position at the interface. Since the location of the fluid interface is monitored geometrically, the method is very effective in representing the interface of immiscible fluids. For accurate tracking, such techniques as the particle level set method were developed. However, the distance function is limited in that it cannot represent miscible fluids. Miscible fluids can be handled effectively by using volume fractions because it is sufficient to trace only the volume fraction of each fluid in a cell. However, it is difficult to simulate immiscible fluids with the volume fractions.

Accordingly, in the present invention, the two representation schemes are combined to provide a technique capable of effectively representing both miscible and immiscible fluids.

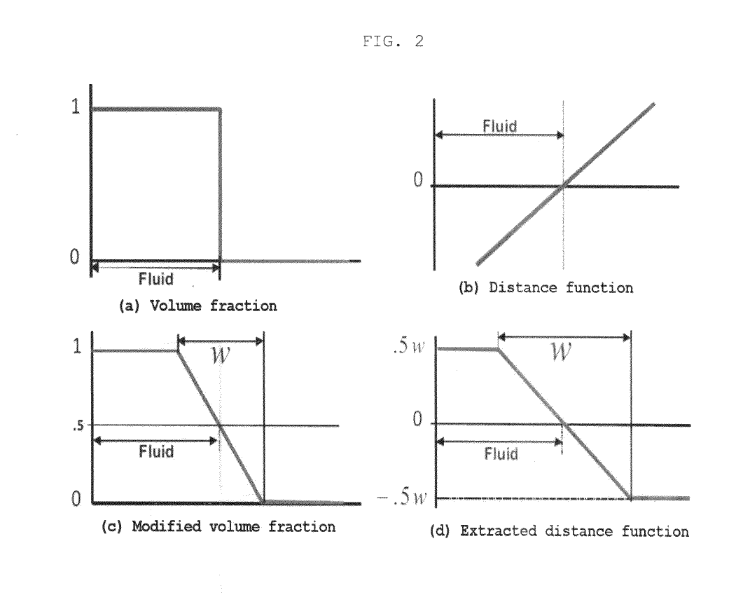

The key point of the present invention is to trace multiple fluids through volume fractions basically, and convert the volume fractions to distance functions near the interface of immiscible fluids. As seen in FIG. 2 (a), the volume fraction of each fluid makes a very sharp transition across the fluid interface. This change results in instability in calculating differential quantities near the interface. On the other hand, if the distance function illustrated in FIG. 2 (b) is used, smooth slopes and stable differential quantities are attained near the interface. Thus, as illustrated in FIG. 2 (c), the volume fractions are modified in the region near the interface to smoothly vary across using the distance function. In particular, the fast marching method is used. Through this modification, while using volume fractions to represent multiple fluids, it is possible to handle immiscible fluids near the interface as if using the distance function.

Also, as illustrated in FIG. 2 (d), the volume fractions can be converted to distance functions, and the level set method may be directly employed. The conversion equation is as follows.

φ(x)=w(α(x)−0.5). (1)

When converting the volume fractions using the fast marching method, the total sum of the volume fractions should be between 0 and 1. This adjustment can be achieved through a simple clamping process. In order to apply this method to multiple fluids, the volume fractions of the individual fluids are computed and they are converted into distance functions near the interface. Then, the volume fractions of the individual fluids are rescaled by the volume fractions of the fluid group.

Now, it is described how the Navier-Stokes equations for the multiple fluids with variable densities and viscosities are solved numerically. The following Navier-Stokes equations are employed.

$$\begin{matrix}{u}_{t} = - ( u \cdot ∇ ) u - \frac{1}{ρ} ∇ p + \frac{1}{ρ} ∇ \cdot τ + f , & ( 2 ) \\ ∇ \cdot u = 0 , & ( 3 ) \\ τ = μ ( ∇ u + {( ∇ u )}^{T} ) , & ( 4 )\end{matrix}$$

where u is velocity, μ is viscosity, p is pressure, ρ is density, τ is the viscous shear stress tensor, and f represents body forces. It is important that Equation (3) holds only when the incompressibility condition of fluid is satisfied. The incompressibility condition is satisfied when the density of the fluid does not change with time. However, with the multiple fluids involved in the simulation according to the present invention, the density may change variously depending on their mixing portions. Thus, Equation (3) appears not to be satisfied. Equation (3) is derived from Equation (5) under the assumption that the density is constant.

$$\frac{\partial ρ}{\partial t} + ∇ \cdot ( ρ u ) = 0. \qquad ( 5 )$$

Let us solve Equation (5) for multiple fluids. Assume that there exist N multiple fluids and the density of fluid f is ρ^{f}. From Equation (5) and Gauss' theorem, Equation (6) is derived.

$$\frac{\partial {α}^{f} {ρ}^{f}}{\partial t} + ∇ \cdot ( {α}^{f} {ρ}^{f} u ) = 0. \qquad ( 6 )$$

If individual density of each fluid is constant, Equation (6) is reduced to Equation (7).

$$\frac{\partial {α}^{f}}{\partial t} + ∇ \cdot ( {α}^{f} u ) = 0. \qquad ( 7 )$$

Adding Equation (7) for all the N fluids f, Equation (8) is obtained. Finally, from Equation (9), the same equation as Equation (3) is obtained.

$$\begin{matrix}\frac{\partial \sum {α}^{f}}{\partial t} + ∇ \cdot ( ( \sum {α}^{f} ) u ) = 0 & ( 8 ) \\ {\sum }_{f} {α}^{f} = 1 & ( 9 )\end{matrix}$$

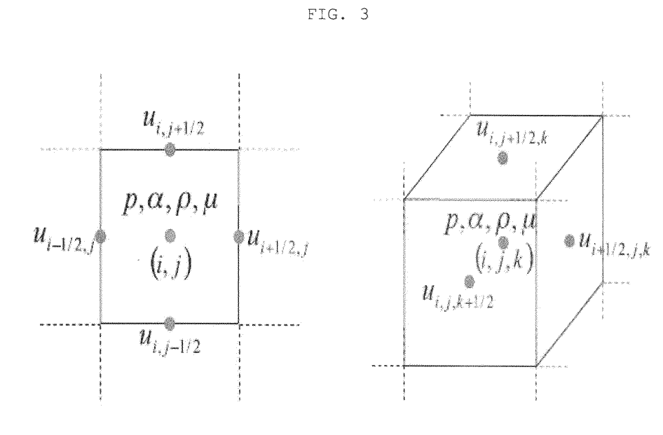

This derivation shows that if each fluid of multiple fluids is incompressible and has a constant density, there mixtures also satisfy the incompressibility condition even though they are mixed with one another. The Navier-Stokes equations represented by Equation (2) may be stably solved numerically using the operator-splitting method proposed by Stam. According to this method, after the advection term, the body force term and the velocity field projection term of the Navier-Stokes equations are solved using the lattice illustrated in FIG. 3, the viscosity term is solved and then the velocity field projection term is solved again. The advection term is solved using the semi-Lagrangian method or the back and forth error compensation and correction (BFECC) scheme.

For the velocity field projection, a linear system called the Poisson's equation is solved, with discontinuity and continuity of density correctly adjusted.

In the present invention, the discontinuity and continuity of density are adjusted as follows. The Poisson equation for solving the velocity field projection term is given by Equation (10).

$$∇ \cdot \tilde{u} - ∇ \cdot \frac{Δ t}{ρ} ∇ p = 0 \qquad ( 10 )$$

Discretizing on the lattice of FIG. 3 gives Equation (11).

$${β}_{i + 1 / 2} {p}_{i + 1} + {β}_{i - 1 / 2} {p}_{i - 1} - ( {β}_{i + 1 / 2} + {β}_{i - 1 / 2} ) {p}_{i} = \frac{Δ x}{Δ t} ( {\tilde{u}}_{i + 1 / 2} - {\tilde{u}}_{i - 1 / 2} ) , \qquad ( 11 )$$

where β is the reciprocal of density, and ũ is the intermediate velocity. Since the linear system of equations that result from Equation (11) is symmetric and positive-definite, the conjugate gradient method can be employed to stably and effectively find the solutions. By substituting the resulting solution in Equation (12), the velocity field satisfying incompressibility is obtained.

$${u}^{n + 1} = {u}^{n} - \frac{Δ t}{ρ} ∇ p . \qquad ( 12 )$$

A difficulty in the velocity field projection is how to estimate the variable coefficients β. Let Gᵢ be the dominant fluid group that occupies the most space in cell i.

The aggregate density ρᵢ for the group is given by Equation (13).

(Σ_{kεG}_{ᵢ}α^{k}ρ^{k})/(Σ_{kεG}_{ᵢ}α^{k}). (13)

If the dominant groups at cell i and cell i+1 are the same, it can be concluded that the fluids in the two cells are miscible and that the density is continuous. Otherwise, in the case of Equation (14), there is a discontinuous interface between cell i and cell i+1. In this case, the density should be determined by the discontinuity fluid method.

(Gᵢ≠Gᵢ₊₁) (14)

Thus, when considering the two cases, β is estimated by Equation (15).

$${β}_{i + 1 / 2} = \{ \begin{matrix}\frac{2}{{ρ}_{i} + {ρ}_{i + 1}} & if {G}_{i} = {G}_{i + 1} , \\ \frac{{β}_{i} {β}_{i + 1}}{( 1 - θ ) {β}_{i} + {θβ}_{i + 1}} & otherwise .\end{matrix} \qquad ( 15 )$$

θ is defined in terms of the level set values. In the present invention, the level set values can be attained from Equation (1).

Now, it is described how the viscosity term of the Navier-Stokes equations is solved in consideration of variable viscosity. Under the assumption that the density is constant, Equation (17) is employed for the viscosity calculation.

$${u}_{t} = \frac{1}{ρ} ∇ \cdot μ ( ∇ u + {( ∇ u )}^{T} ) . \qquad ( 17 )$$

However, the discretization of Equation (17) results in a non-symmetric system, because the density is variable. Hence, it is difficult to stably find the solutions numerically. Accordingly, in the present invention, a new viscosity equation that can be discretized as a symmetric and positive-definite linear system is derived under the assumption that the density of individual fluids is constant.

The viscosity equation employed in the operator-splitting framework is given by Equation (18).

$${u}_{t} = \frac{1}{ρ} ∇ \cdot τ , or ρ {u}_{t} = ∇ \cdot τ , \qquad ( 18 )$$

where

τ=μ(∇u+(∇u)^{T}). (19)

For each fluid f, Equation (20) and Equation (21) are derived.

ρ^{f}uₜ=∇·τ^{f}, (20)

τ^{f}=μ^{f}(∇u+(∇u)^{T}) (21)

Integrating over a cell gives Equation (22).

α^{f}∫_{c}ρ^{f}uₜdV=α^{f}∫_{c}∇·τ^{f}dV. (22)

Since the volume fraction is assumed to be constant within a cell, Equation (23) is derived.

α^{f}∫_{c}ρ^{f}uₜdV=∫_{c}α^{f}ρ^{f}uₜdV. (23)

From the Gauss' theorem, Equation (24) is derived.

α^{f}∫_{c}∇·τ^{f}dV=α^{f}∫_{∂c}τ^{f}dS=∫_{∂c}α^{f}τ^{f}dS=∫_{c}∇·(α^{f}τ^{f})dV. (24)

Therefore, Equation (25) is obtained, and dividing both sides by ρ^{f} gives Equation (26).

α^{f}ρ^{f}uₜ=∇·(α^{f}τ^{f}). (25)

α^{f}uₜ=∇·(α^{f}τ^{f}/ρ^{f}). (26)

Summing these equations over all fluids gives Equation (27).

Σα^{f}uₜ=∇·Σ(α^{f}τ^{f}/ρ^{f}) (27)

which is simplified to Equation (28) and Equation (29).

uₜ=∇·ν(∇u+(∇u)^{T}), (28)

ν=Σα^{f}(μ^{f}/ρ^{f}). (29)

This equation can be discretized to yield a symmetric and positive-definite linear system. The aggregate viscosity constant νᵢ of the fluid group Gᵢ is computed by Equation (30), where Equation (31) holds.

νᵢ=(Σ_{kεG}_{ᵢ}α^{k}ν^{k})/(Σ_{kεG}_{ᵢ}α^{k}), (30)

ν^{k}=(μ^{k}/ρ^{k}). (31)

ν_{i+1/2} is computed by Equation (32) in a similar manner as β_{i+1/2}.

$${v}_{i + 1 / 2} = \{ \begin{matrix}\frac{{v}_{i} + {v}_{i + 1}}{2} & if {G}_{i} = {G}_{i + 1} , \\ \frac{{v}_{i} {v}_{i + 1}}{( 1 - θ ) {v}_{i} + θ {v}_{i + 1}} & otherwise .\end{matrix} \qquad ( 32 )$$

For volume fraction advection, the BFECC method and the particle level set method are combined in the present invention. First, all the individual fluids flowing in the incompressible velocity field are traced by the BFECC method. With the BFECC method only, unwanted effects such as fluid volume loss, interface overlaps and vacuum holes may occur due to numerical errors. In order to alleviate these problems, the volume fractions are converted to the distance functions using Equation (1), and the particle level set method is applied. Specially, the method which extends the level set method presented by Losasso et al. to multiple immiscible fluids [Losasso F., Shinar T., Selle A., Fedkiw R.: Multiple interacting liquids. ACM Trans. Graph. 25, 3 (2006), 812-819.] is employed. Since the volume fractions of every miscible fluid in the fluid group are corrected by the particle level set method, each particle should convey not only the level set value but also the volume fractions of the individual fluids.

Then, after selecting two fluid groups having the largest distance function values such that there remain at most two fluid groups in a cell, the average of the two largest level set values is subtracted to prevent the interface overlaps and vacuums. Following this correction, the distance functions are converted back to the volume fractions.

In order to treat diffusion between miscible fluids, Equation (33) is further introduced in the present invention, where Equation (34) holds and D is the diffusion coefficient.

$$\begin{matrix}\frac{\partial α}{\partial t} = ∇ \cdot J & ( 33 ) \\ J = D ∇ α & ( 34 )\end{matrix}$$

Since the diffusion flux must be zero between immiscible fluids, Equation (35) should hold across the interface of miscible fluids.

J=0 (35)

In order to effectively implement this, the notion of the dominant group defined above is exploited. The dominant group of each cell is found out, and the simulation domain is portioned into subregions, such that each subregion contains the same dominant group. Then, the diffusion is done separately in each region, using the diffusion equation defined by Equation (33). The Neumann boundary condition prevents the diffusion out of the dominant group. For a fluid with a large diffusion coefficient, explicit numerical integration of the diffusion equation is often unstable with large simulation time steps. Therefore, a linear system may be used to obtain stable numerical solutions. Discretization on the lattice space gives Equation (36) and Equation (37).

−λαᵢ₋₁^{new}+(1+2λ)αᵢ^{new}−λαᵢ₊₁^{new}=αᵢ, (36)

∇α·n=0 on the boundary, (37)

where Equation (38) holds and n is the normal vector at the interface.

$$λ = \frac{D Δ t}{Δ {x}^{2}} \qquad ( 38 )$$

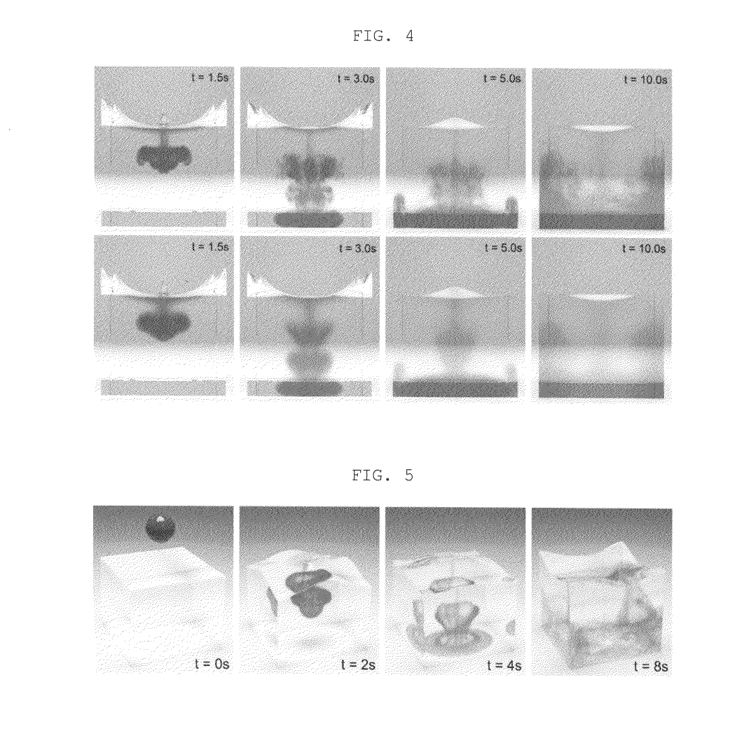

FIG. 4 shows an example of simulation of miscible fluids with different diffusion coefficients.

The diffusion of miscible fluids is characteristic in that the sum of the volume fractions of each fluid group in a cell remains constant although the volume fractions within the group can be changed during the diffusion. However, the fast marching method introduced to take advantage of the distance function near the interface results in unwanted change of the volume fractions. Therefore, to correct the errors, the volume fractions in each group are rescaled after diffusion so that their sum remains the same as before.

In general, diffusion of fluid is defined based on mass fractions. However, in the present invention, the volume fractions are used instead of the mass fractions since the fluids are incompressible. To satisfy the incompressibility, the exchange of volume fractions during the fluid diffusion should be balanced. Therefore, all fluids in the same group should have the same diffusion coefficients.

Now, the diffusion coefficients of miscible fluids will be considered. Let two miscible fluids, A and B in cell i and cell i+1, respectively. The diffusion fluxes for the fluids are given by Equation (39) and Equation (40).

$$\begin{matrix}{J}_{right}^{A} = {D}^{A} \frac{{α}_{i + 1}^{A} - {α}_{i}^{A}}{Δ x} & ( 39 ) \\ {J}_{left}^{B} = {D}^{B} \frac{{α}_{i + 1}^{B} - {α}_{i}^{B}}{Δ x} , & ( 40 )\end{matrix}$$

where J_{right}^{A} and J_{left}^{B} are the diffusion flux of fluid A along the rightward direction in cell i and the diffusion flux of fluid B along the leftward direction in cell i+1, respectively. The incompressibility condition requires that the fluxes be balanced. Hence, Equation (41) holds, which is reduced to Equation (42). From Equation (43), Equation (44) is derived.

$$\begin{matrix}{D}^{A} \frac{{α}_{i + 1}^{A} - {α}_{i}^{A}}{Δ x} + {D}^{B} \frac{{α}_{i + 1}^{B} - {α}_{i}^{B}}{Δ x} = 0. & ( 41 ) \\ {D}^{A} ( {α}_{i + 1}^{A} - {α}_{i}^{A} ) + {D}^{B} ( {α}_{i + 1}^{B} - {α}_{i}^{B} ) = 0. & ( 42 ) \\ {α}^{B} = 1 - {α}^{A} & ( 43 ) \\ ( {D}^{A} - {D}^{B} ) {α}_{i + 1}^{A} + ( {D}^{A} - {D}^{B} ) {α}_{i}^{A} = 0. & ( 44 )\end{matrix}$$

Since the above equality is satisfied for arbitrary α^{A}, Equation (45) is derived. This also holds true for three or more fluids.

D^{A}=D^{B} (45)

In order to visualize the interface between immiscible fluids, the 0.5 isosurface may be extracted using the marching cube scheme [Lorensen W. E., Cline H. E.: Marching cubes: A high resolution 3D surface construction algorithm. SIGGRAPH Comput. Graph. 21, 4 (1987), 163-169.]. Alternatively, the ray marching method [Crane K., Llamas I., Tariq S.: Real-time simulation and rendering of 3D fluids. GPU Gems 3 Chapter 30 (2007). 7] may be used. Volume rendering may be employed to render smooth transition of miscible fluids. A detailed description will be omitted since it is already known in the art. In an embodiment of the present invention, PBRT [Pharr M., Humphreys G.: Physically Based Rendering: From Theory to Implementation. Morgan Kaufmann, 2004.] may be used.

The present invention provides a method that can simulate the flow of multiple fluids including miscible and immiscible fluids. Through conversion between the volume fractions and the level set functions, the present invention takes advantages of the both methods. The volume fractions are employed as the basic representation scheme for simulation and, near the interface, the volume fractions are converted to the level set functions to find appropriate solutions. From the technical point of view, the major contribution of the present invention is to provide an approach to simulation of multiple fluids having variable densities and viscosities. Especially, the method according to the present invention satisfies the incompressibility condition of fluids, is capable of treating variable density and viscosity, can combine the volume fractions with the distance functions, and can simplify the diffusion phenomena.

Since the present invention is based on the standard operator-splitting framework, differently from the lattice Boltzmann method-based methods, it can be easily integrated into existing fluid simulation design techniques.

In order to demonstrate the effect of the method provided by the present invention, simulation was performed on Intel Core2 Quad Q8400 CPU with 6 GB RAM. Uniform grids were used to discretize the simulation space, and the time step was set as 2 times the Courant-Friedrichs-Lewy (CFL) number. In each iteration of simulation, it took about 5 to 40 seconds for solving the Navier-Stokes equations, and 20 to 90 seconds for advection and diffusion. 5 to 6 iterations were performed per frame on average. The most time-consuming part was volume fraction correction using the particles in the advection and diffusion step. The volume fractions of each cell were represented as an N-vector where N is the number of fluids in the cell. Since level set values were computed whenever needed, no extra space was used to store them. For the particle level set method, each particle conveys a vector of volume fractions of a group, which incurs additional space.

The following three examples were used to support that the method proposed by the present invention can handle multiple miscible fluids of variable densities and viscosities, under the incompressibility assumption on each individual fluid.

In the first example, a red fluid drop falling into water in a container represented by a 100×200×100 grid was simulated. It is observed that the red drop was smoothly mixed with transparent water as shown in FIG. 5. This experiment was repeated by varying fluid densities, viscosities, and diffusion coefficients.

The second example shows a phenomenon of mixing honey (yellow) and water (transparent) of which the viscosities are greatly different from each other (FIG. 6). Two fluid columns were initially located at the diagonally opposite corners of a 100×100×150 grid. A significantly (10000 times) higher viscosity was assigned to honey than water. Because of high viscosity contrast, the two fluids showed very different behaviors in the beginning of simulation although they were miscible with each other. After sufficient material diffusion, they behaved similarly because of the composite viscosity of their mixture.

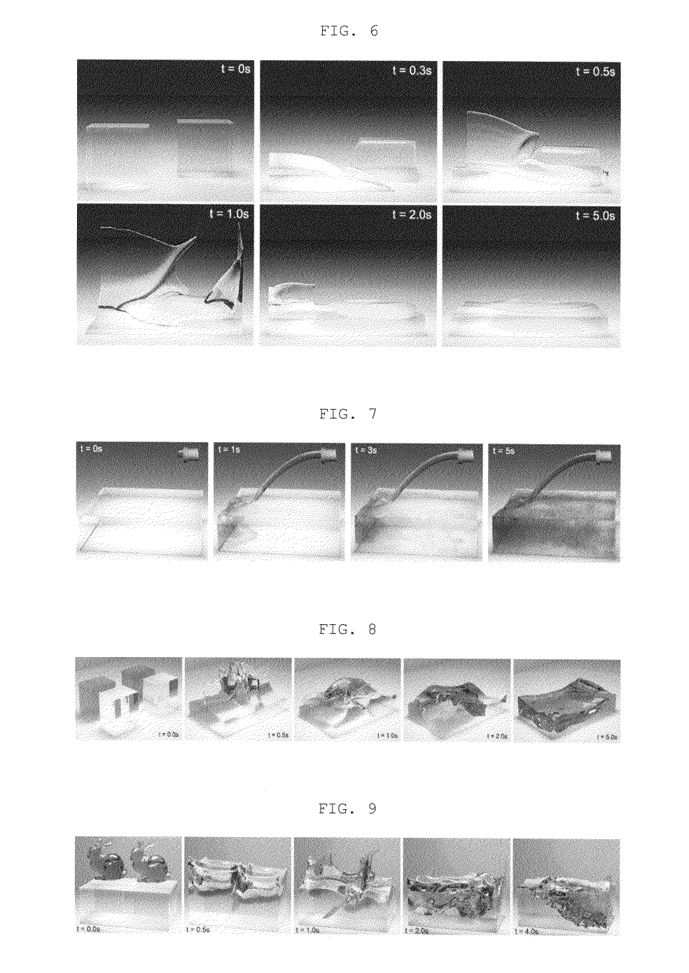

In the last example, three colored fluids pouring into transparent water in a 100×100×50 grid were simulated. The three fluids are colored red, blue and green, and their densities were set as follows: ρ_{red}>ρ_{blue}>ρ_{green}. The four fluids are miscible with each other. Each of the three colored fluids was poured into water in turn. As shown in FIG. 7, four different fluids were mixed together to result in complex color gradation inside water. This example demonstrates that the method provided by the present invention can be used as a general tool to simulate miscible fluid flows.

Through another three examples, it was validated that the method provided by the present invention effectively handles multiple miscible and immiscible fluids simultaneously.

The first example shows a quadruple dam breaking scene simulated on a 100×150×150 grid. For this scene, four columns of fluids colored red, green, yellow and transparent were used. Their densities were set as follows: ρₜᵣₐₙₛₚₐᵣₑₙₜ>ρ_{green}>ρ_{red}>ρ_{yellow}. They formed two groups of fluids, {red, yellow} and {green, transparent}. Red and yellow fluid columns were placed initially in the right side of the container. Green and transparent fluid columns were in the opposite side. As shown in FIG. 8, the method allows the miscible fluids in each group to diffuse to each other while exhibiting sharp interface between the two groups.

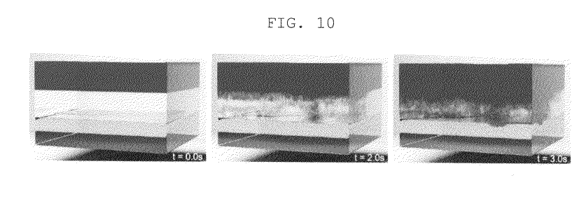

The next example exhibits two bunny-shaped fluid chunks falling into two immiscible fluids at the bottom of a 100×150×150 grid. The two fluid chunks are miscible with the different fluids at the bottom. The densities of the four fluids were set as follows: ρ_{red}>ρ_{yellow}>ρ_{blue}>ρₜᵣₐₙₛₚₐᵣₑₙₜ. The diffusion coefficient between the red and the yellow fluids was set larger than that between the blue and the transparent fluids. Accordingly, the red fluid chunk diffused to the yellow fluid faster than the blue chunk diffused to the transparent fluid, as shown in FIG. 9.

The last example shows Rayleigh-Taylor instability with three layered fluids. The experiment was performed on a 150×150×150 grid using two groups of fluid, {blue, transparent} and {dark}. The density of the blue fluid was larger than that of the transparent fluid, which caused Rayleigh-Taylor instability between the two miscible fluids. FIG. 10 shows a complex mixing phenomenon of the two miscible fluids because of the instability while keeping the discontinuous interface with the dark fluid.

Now, a method of a hybrid approach to multiple fluid simulation using volume fractions for realizing computer graphics through analysis of the Navier-Stokes equations, which is executed via a computer and takes into account variable densities resulting from N multiple fluids existing in multiple lattice cells will be described.

First, N fluids are classified into n fluid groups according to their physical properties. Each fluid group may be a mixture of miscible fluids.

Then, the volume fractions of the fluids in each cell are computed and stored (S101). Then, the volume fractions of the fluids are converted into distance functions and stored (S102). The volume fraction of fluid f occupying a volume v of the lattice cell volume V is determined by v/V. Then, the sum of the volume fractions in each cell may be adjusted to be 1.

In the present invention, the volume fractions are converted to the distance functions to utilize the level set method. Preferably, the distance function is one represented by Equation (1). In Equation (1), the Heaviside function α(x) is defined as 1 if x is a point in the region occupied by the fluid and 0 otherwise.

Then, among the fluids in each cell, the dominant fluid which has the largest volume fraction is determined (S103). The dominant fluid is determined to reflect the continuity and discontinuity of the density and viscosity between cells, as described earlier in detail.

Then, the variable density of each lattice cell is computed (S104), and the velocity field of the lattice cell is computed based on the variable density (S105).

If the variable viscosity is not considered, the procedure may end at operation S105. If the variable viscosity is considered, the variable viscosity of each lattice cell is computed (S106), the velocity field is computed again based on the computed variable viscosity (S107), and then the volume fractions of all the fluids moving in the velocity field are computed again (S108).

Preferably, the velocity field is computed using the conjugate gradient method, and the re-calculation of the velocity field is performed by superimposing the values computed by solving the viscosity term of the Navier-Stokes equations with the velocity field values computed earlier. Preferably, the re-calculation of the volume fractions of all the fluids moving in the re-calculated velocity field is computed using the BFECC method.

Further, at the interface of the lattice cells with different dominant fluids, the Neumann boundary condition may be applied to the computed velocity field, so as to control the diffusion of fluids (S109). Preferably, the Neumann boundary condition makes the value along the normal direction vanish.

In addition to the analysis method, the present invention also provides a recording medium wherein a program of a method of a hybrid approach to multiple fluid simulation using volume fractions for realizing computer graphics through analysis of the Navier-Stokes equations, which is executed via a computer and takes into account variable densities resulting from N multiple fluids existing in multiple lattice cells, is recorded.

Since the hybrid approach to multiple fluid simulation using volume fractions included in the program is the same as described above, a detailed description thereof will be omitted.

While the present invention has been described with respect to the specific embodiments, it will be apparent to those skilled in the art that various changes and modifications may be made without departing from the spirit and scope of the invention as defined in the following claims.

What is claimed is:

1. A method of a hybrid approach to multiple fluid simulation using volume fractions for realizing computer graphics through analysis of the Navier-Stokes equations, which is executed via a computer and takes into account variable densities resulting from N multiple fluids existing in multiple lattice cells, comprising: classifying N fluids into n fluid groups according to their physical properties; computing and storing volume fractions of the fluids in each lattice cell; converting the volume fractions of the fluids into distance functions and storing them; determining the dominant fluid which has the largest volume fraction in each lattice cell; computing variable density of each lattice cell; and computing velocity field of each lattice cell using the computed variable density.

2. A method of a hybrid approach to multiple fluid simulation using volume fractions for realizing computer graphics through analysis of the Navier-Stokes equations, which is executed via a computer and takes into account variable densities resulting from N multiple fluids existing in multiple lattice cells, comprising: computing and storing volume fractions of the fluids in each lattice cell; converting the volume fractions of the fluids into distance functions and storing them; determining the dominant fluid which has the largest volume fraction in each lattice cell; computing variable density of each lattice cell; and computing velocity field of each lattice cell using the computed variable density.

3. A method of a hybrid approach to multiple fluid simulation using volume fractions for realizing computer graphics through analysis of the Navier-Stokes equations, which is executed via a computer and takes into account variable densities and variable viscosities resulting from N multiple fluids existing in multiple lattice cells, comprising: computing and storing volume fractions of the fluids in each lattice cell; converting the volume fractions of the fluids into distance functions and storing them; determining the dominant fluid which has the largest volume fraction in each lattice cell; computing variable density of each lattice cell; computing velocity field of each lattice cell using the computed variable density; computing variable viscosity of each lattice cell; computing the velocity field of each lattice cell again using the computed variable viscosity; and computing again the volume fractions of all the fluids moving in the velocity field.

4. The method of a hybrid approach to multiple fluid simulation using volume fractions according to claim 1, wherein, at the interface of the lattice cells with different dominant fluids, the Neumann boundary condition is applied to the computed velocity field, so as to control the diffusion of fluids.

5. The method of a hybrid approach to multiple fluid simulation using volume fractions according to claim 1, wherein the distance function φ(x) satisfies the relationship φ(x)=w(α(x)−0.5). where w is a predetermined interface gap between lattice cells and α(x) is the Heaviside function defined as 1 if x is a point in the region occupied by the fluid and 0 otherwise.

6. The method of a hybrid approach to multiple fluid simulation using volume fractions according to claim 1, wherein the volume fraction is determined by the volume v occupied by a fluid in the lattice cell divided by the volume V of the lattice cell.

7. The method of a hybrid approach to multiple fluid simulation using volume fractions according to claim 1, wherein the sum of the volume fractions in each cell is adjusted to be 1.

8. The method of a hybrid approach to multiple fluid simulation using volume fractions according to claim 1, wherein β, i.e. the inverse of density ρᵢ, satisfies the relationship
$${β}_{i + 1 / 2} = \{ \begin{matrix}\frac{2}{{ρ}_{i} + {ρ}_{i + 1}} & if {G}_{i} = {G}_{i + 1} , \\ \frac{{β}_{i} {β}_{i + 1}}{( 1 - θ ) {β}_{i} + {θβ}_{i + 1}} & otherwise .\end{matrix}$$
where θ is defined as
$$θ = \frac{\vert φ ( {x}_{i} ) \vert}{\vert φ ( {x}_{i} ) \vert + \vert φ ( {x}_{i + 1} ) \vert} ,$$
and G represents the dominant fluid of the lattice cell.

9. The method of a hybrid approach to multiple fluid simulation using volume fractions according to claim 1, wherein said computing the velocity field comprises solving the Poisson equation.

10. The method of a hybrid approach to multiple fluid simulation using volume fractions according claim 3, wherein said computing the velocity field again comprises superimposing the values computed by solving the viscosity term of the Navier-Stokes equations with the velocity field values computed earlier.

11. The method of a hybrid approach to multiple fluid simulation using volume fractions according to claim 4, wherein the Neumann boundary condition makes the value along the normal direction vanish.

12. The method of a hybrid approach to multiple fluid simulation using volume fractions according to claim 1, wherein the velocity field is computed using the conjugate gradient method.

13. The method of a hybrid approach to multiple fluid simulation using volume fractions according claim 3, wherein, the BFECC method is used in said computing again the volume fractions of all the fluids moving in the velocity field.

14. A recording medium wherein a program of a hybrid approach to multiple fluid simulation using volume fractions for realizing computer graphics through analysis of the Navier-Stokes equations, which is executed via a computer and takes into account variable densities resulting from N multiple fluids existing in multiple lattice cells, is recorded, the method comprising: classifying N fluids into n fluid groups according to their physical properties; computing and storing volume fractions of the fluids in each lattice cell; converting the volume fractions of the fluids into distance functions and storing them; determining the dominant fluid which has the largest volume fraction in each lattice cell; computing variable density of each lattice cell; and computing velocity field of each lattice cell using the computed variable density.

15. A recording medium wherein a program of a hybrid approach to multiple fluid simulation using volume fractions for realizing computer graphics through analysis of the Navier-Stokes equations, which is executed via a computer and takes into account variable densities resulting from N multiple fluids existing in multiple lattice cells, is recorded, the method comprising: computing and storing volume fractions of the fluids in each lattice cell; converting the volume fractions of the fluids into distance functions and storing them; determining the dominant fluid which has the largest volume fraction in each lattice cell; computing variable density of each lattice cell; and computing velocity field of each lattice cell using the computed variable density.

16. A recording medium wherein a program of a hybrid approach to multiple fluid simulation using volume fractions for realizing computer graphics through analysis of the Navier-Stokes equations, which is executed via a computer and takes into account variable densities resulting from N multiple fluids existing in multiple lattice cells, is recorded, the method comprising: computing and storing volume fractions of the fluids in each lattice cell; converting the volume fractions of the fluids into distance functions and storing them; determining the dominant fluid which has the largest volume fraction in each lattice cell; computing variable density of each lattice cell; computing velocity field of each lattice cell using the computed variable density; computing variable viscosity of each lattice cell; computing the velocity field of each lattice cell again using the computed variable viscosity; and computing again the volume fractions of all the fluids moving in the velocity field.
